(19) United States
(12) Patent Application Publication
(10) Pub. No.: US 2021/0295390 A1
(43) Pub. Date: Sep. 23, 2021

(54) Artificial Intelligence Based System and Method of Tracking Travel Patterns of Mobile Shoppers

(71) Applicant: International Business Machines Corporation, Armonk, NY (US)

(72) Inventors: Manjit Singh Sodhi, Bangalore (IN); Raghuveer Prasad Nagar, Bangalore (IN)

(21) Appl. No.: 16/826,827

(22) Filed: Mar. 23, 2020

(51) Int. Cl. G06Q 30/02; H04W 4/021; G16Y 10/45

(52) U.S. Cl. CPC G06Q 30/0276; G06Q 30/0214; G16Y 10/45; H04W 4/021; G06Q 30/0205

(57) ABSTRACT

A method, system and computer-usable medium are disclosed for deriving a region in which brand awareness is supported. Shoppers are detected in the region where brand awareness is to be supported, where such shoppers can be brand ambassadors. Items used for brand awareness are determined as to the brand ambassadors. Items are offered to the brand ambassadors, where the items can promote brand awareness.

### BACKGROUND OF THE INVENTION

### Field of the Invention

The present invention relates in general to the field of computers and similar technologies, and in particular to software utilized in this field. Still more particularly, the present invention relates to a method, system and computer-usable medium using artificial intelligence to determine brand ambassadors based on travel patterns of mobile shoppers.

### Description of the Related Art

Businesses continually strive to create, maintain and increase commerce and sales, finding ways to attract and retain customers. Creating commerce is important for businesses entering markets. Established businesses need to maintain and grow commerce and their customer base. As new businesses enter markets, they invest in advertising, promotions and create sales campaigns to bring awareness of their products, services, and brand. To maintain and keep with up with new and established competitors in business markets, existing businesses also invest in and establish campaigns and programs in order maintain and grow product, service, and brand awareness and sales.

Growing product, service, and brand awareness through ways such as traditional advertising, campaigns, and promotions can be a very costly investment for businesses. In many cases, such investments are reoccurring. For example, if a promotional event takes place annually, each time of year the promotional event takes place new costs are incurred. If a celebrity is paid to endorse and promote the business, the contract of the celebrity takes place over a certain time, expires, and has to be renewed. Creating, maintaining, and growing product, service and brand awareness is a necessary and considerable party of business expenses. Traditionally methods of creating, maintaining, and growing product, service and brand awareness for businesses comes at a substantial cost.

### SUMMARY OF THE INVENTION

A method, system and computer-usable medium are disclosed for deriving a region in which brand awareness is supported. Shoppers are detected in the region where brand awareness is to be supported, where such shoppers can be brand ambassadors. Items used for brand awareness are determined as to the brand ambassadors. Items are offered to the brand ambassadors, where the items can promote brand awareness.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts an example information handling system that can be used to implement the system and method of the present invention;

FIG. 2 is a general illustration of a system that supports tracking mobile shoppers to determine brand ambassadors;

FIG. 3 depicts relationship of a mobile shopper with various regions;

FIG. 4 is a general illustration of receiving various data to determine routes and regions of mobile shoppers; and

FIG. 5 is a generalized flowchart of the operation of determining brand ambassadors based on travel patterns of mobile shoppers.

### DETAILED DESCRIPTION

A system, method, and computer-readable medium are disclosed for artificial intelligence (AI) to determine brand ambassadors based on travel patterns of mobile shoppers. Described herein is an AI based and Internet of Things (IoT) based system and method that determines regions where brand awareness for business is to be grown and increased.

People travel, where the travel can be personal or business. Travel can regularly occur, such as going to and from home to the office. Or travel can be one time event, such as travelling to a conference for work or vacation for pleasure. People also shop for products and services. Therefore, people are travelers and shoppers. Every shopper can be considered a traveler.

Shoppers are determined as to regions, where such shoppers can be brand ambassadors for the businesses. In certain implementations, shoppers that are determined to be brand ambassadors are offered or given items as a gift or at a discounted price. The determined regions can be geographical areas or travel routes.

The shoppers can be detected based on the routes they travel frequently. In certain implementations, regions needing marketing (i.e., to create, maintain and/or grow product, service and/or brand awareness) are matched with the regions a shopper(s) travels frequently. Traveling can be through public or private transportation.

Items that are given to or discounted to shoppers who are brand ambassadors, can be determined for example, by “exposure of use of the item is made to non-brand ambassadors or non-shoppers” and “brand exposure of the item.” Items can range from existing products and services to “made to order” or custom products and services.

For the purposes of this disclosure, a computing device or an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile device such as a tablet or smartphone, a consumer electronic device, a connected “smart device,” a network appliance, a network storage device, a network gateway device, a server or collection of servers or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more wired or wireless interfaces for communicating with other networked devices, external devices, and various input and output (I/O) devices, such as a keyboard, a mouse, a microphone, speakers, a track pad, a touchscreen and a display device (including a touch sensitive display device). The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or solid state drive), a sequential access storage device (e.g., a tape disk drive), optical storage device, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

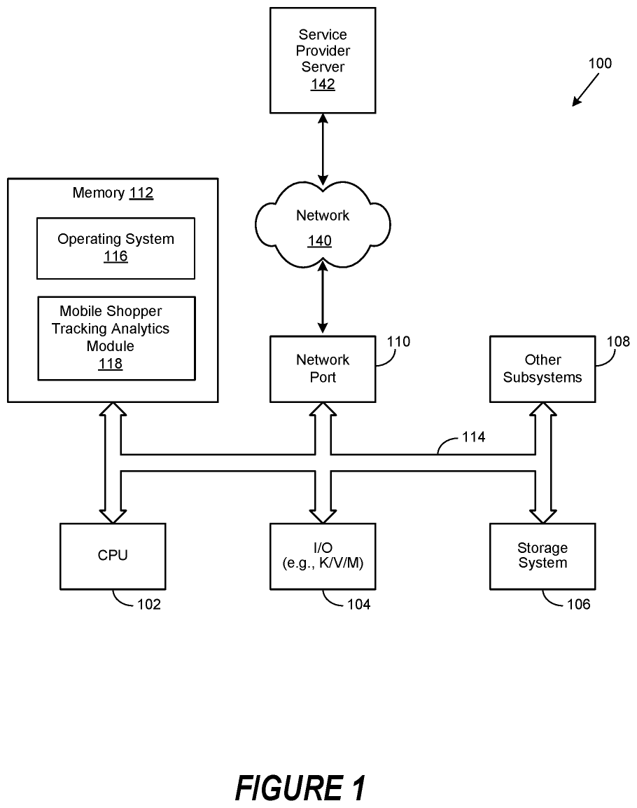

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a storage system 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further includes operating system (OS) 116 and in various embodiments may also include a mobile shopper tracking analytics module 118. The mobile shopper tracking analytics module 118 can implement artificial intelligence (AI) in tracking shoppers and providing recommendations as to the brand ambassadors, items to be given or discounted to brand ambassadors, etc.

In one embodiment, the information handling system 100 is able to download the mobile shopper tracking analytics module 118 from the service provider server 142. In another embodiment, the mobile shopper tracking analytics module 118 is provided as a cloud service from the service provider server 142.

In various embodiments, the mobile shopper tracking analytics module 118 performs tracking of mobile shoppers and their routes, matching regions that shoppers travel frequently for potential commerce. The mobile shopper tracking analytics module 118 can correlate products and services used by shoppers as to their travels.

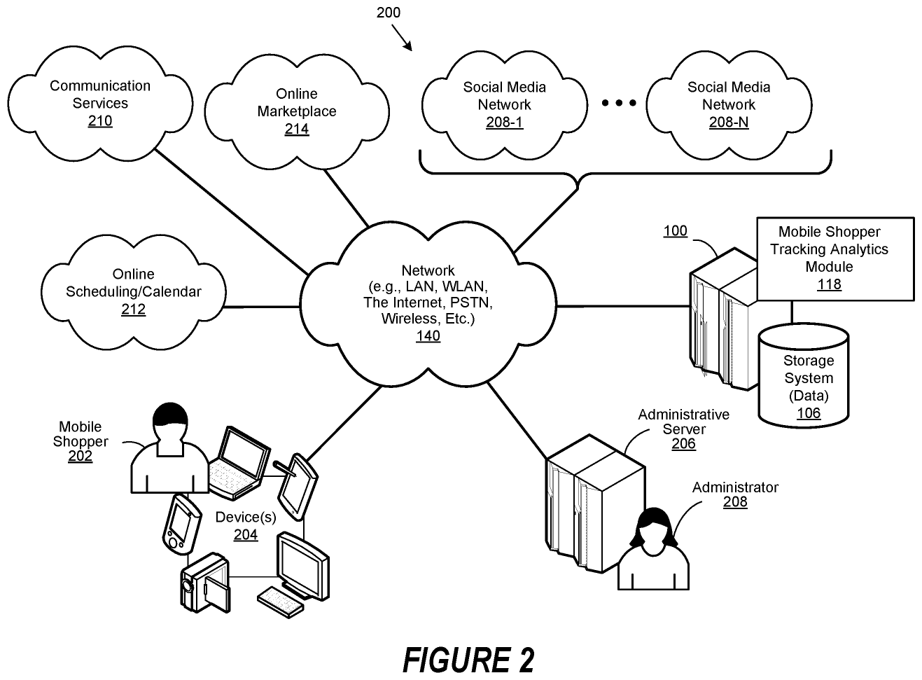

FIG. 2 is a simplified block diagram of a system of tracking mobile shoppers to determine brand ambassadors. The system particularly supports tracking the routes of and shopping patterns and habits of mobile shoppers who can potentially be brand ambassadors for a business or businesses.

The system 200 includes the information handling system 100, the mobile shopper tracking analytics module 118, and the storage system (data) 106. As described information handling system 100 connects with network 140. In particular, the mobile shopper tracking analytics module 118 connects with various entities, components, etc. of system 200 in performing AI based analysis as to shopper routes, brand ambassadors, providing items to brand ambassadors, etc.

In certain embodiments, the network 140 may be a public network, such as the Internet, a physical private network, a wireless (e.g., cellular) network, a virtual private network (VPN), PSTN (public switched telephone network), computer network, or any combination thereof. Skilled practitioners of the art will recognize that many such embodiments are possible, and the foregoing is not intended to limit the spirit, scope or intent of the invention.

Network 140 connects one or more mobile shoppers, as represented by mobile shopper 202. In particular, mobile shopper 202 connects to the network though devices 204. Devices 204 in general, are information handling systems, and can include various computing and communication devices, such as Internet of Things (IoT), where IoT is a system of interrelated computing devices, mechanical and digital machines provided with unique identifiers (UIDs) and the ability to transfer data over network 140 without requiring human-to-human or human-to-computer interaction. Other examples of devices 204 can include a personal computer, a laptop computer, a tablet computer, a personal digital assistant (PDA), a smart phone, a mobile telephone, or other device that is capable of communicating and processing data.

In an embodiment, the system 200 includes an administrative system as represented by administrative server 206 through an administrator 208 is able to access information handling system 100 and particularly the mobile shopper tracking analytics module 118.

The system 200 includes various social media networks as represented by social media network 208-1 to social media network 208-N connected to network 140. Examples of social media networks include Facebook®, Gmail®, Instagram®, etc. In particular implementations, mobile shopper 202 connects and interfaces with one or more of social media network 208-1 to social media network 208-N.

The system 200 can include communication services 210 which are connected to the network 140. Communication services 210 can include cellular telephone services, that can provide voice and text services (i., short message service or SMS). System 200 further can include scheduling/calendar services 212, which can include online, or cloud based scheduling or calendar applications directed to mobile appointments, scheduled, calendar events, etc. related to mobile shopper 202.

Businesses, including those that provide products and services are represented by online marketplace 214. In certain implementations, items that are given or provided at a discount to brand ambassadors which mobile shopper 202 can be one of, are provided through online marketplace 214.

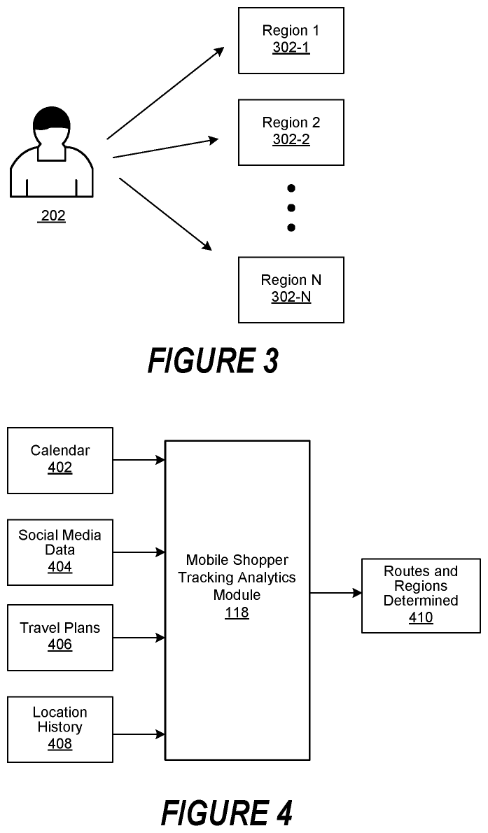

FIG. 3 shows relationship of a mobile shopper with various regions. In an embodiment, the system 200 and particularly the information handling system 100 and the mobile shopper tracking analytics module 118 perform a comparative analysis among various regions to derive the regions needing better brand awareness and sales. Regions can include country, state (province), city, town, a smaller area in a city or town, etc. Regions can also include sets of regions, and a route in which a mobile shopper travels. Mobile shopper 202 can travel to various regions, such as region 1 302-1, region 2 302-2 through region N 302-N. Shoppers, such as mobile shopper 202 are selected as brand ambassadors based on matching regions identified as needing better brand awareness and sales as described with shoppers that are expected to travel to those identified regions. For example, region 2 302-2 is identified as a region needing brand awareness and sales. If mobile shopper 202 travels to region 2 302-2, mobile shopper 202 may be a brand ambassador.

FIG. 4 is a general illustration of receiving various data to determine routes and regions of mobile shoppers. In certain implementations, the information handling system 100 and the mobile shopper tracking analytics module 118, receive and analyze data from various data sources to derive expected travels of mobile shoppers (i.e., mobile shopper 202). For example, routes and regions in which mobile shopper 202 is expected to travel can be received from calendar, or appointment schedules as represented by calendar 402. For example, referring to FIG. 2, calendar 402 data sources can include information from applications on device(s) 204, online scheduling/calendar 212, etc. Such data can include locations, dates, etc. as to calendar events of mobile shopper 202. In certain implementations, cognitive tools, such a search tools can be used to perform real-time searching for additional details.

Another data source can include social media data 404. For example, referring to FIG. 2, social media network 208-1 through social media network 208-N can be searched. As an example, mobile shopper 202 may post comments as to planned travels to certain regions. In certain implementations, cognitive tools, such a search tools can be used to perform real-time searching for additional details.

Another data source can include travel plans 404, as conveyed in messages, such as emails, emails, voice, etc. For example, referring to FIG. 2, social media messages from communication services 210 to and from mobile shopper 202 can be searched. As an example, mobile shopper 202 may post comments as to planned travels to certain regions. In certain implementations, where voice messages are searched, natural language processing (NLP) can be applied.

Yet another data source can include location history 408. Mobile shopper 202 may have traveled to certain regions through certain routes in the past. Such data can be tracked, for example by tracking device(s) 204 of FIG. 2, associated with mobile shopper 202. It is to be understood that other data sources can be used.

The data from the data sources 402, 404, 406 and 406, and any other data sources, can be used alone, collectively, or selectively by the mobile shopper tracking analytics module 118 to provide routes and regions 410 in which mobile shoppers, such as mobile shopper 202 travels.

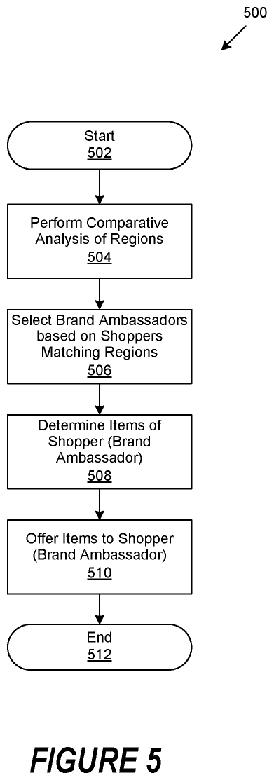

FIG. 5 is a generalized flowchart 500 for determining brand ambassadors based on travel patterns of mobile shoppers. Regions are derived in which brand awareness is supported. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 502, the process 500 starts. At step 504, a comparative analysis of various regions is performed to determine regions in which brand awareness and sales is to be supported or created, sustained and grown. As discussed herein, regions can include country, state (province), city, town, a smaller area in a city or town, etc. Regions can also include sets of regions, and a route in which a mobile shopper travels.

At step 506, shoppers or mobile shoppers are selected as brand ambassadors. In particular, such shoppers are shoppers that travel to the regions that are identified in which brand awareness and sales is to be supported or created, sustained and grown. As discussed herein, various data sources can be used in determining regions. In certain implementations, a time can be configured, or process through machine learning to decide a future time window for which the expected travel for mobile shoppers is analyzed. Certain implementations can take into account travel type, such a single occurring, repeating travel, frequency, etc. Other considerations can include preferring mobile shoppers as brand ambassador who travel frequently to the identified regions.

At step 508, items are determined for the selected brand ambassador. Consideration can be made as to which items brand ambassadors use regularly or the most while traveling. For example, determination can be made based on data from gathered from devices, such as IoT devices, that provide what items a brand ambassador takes and uses when traveling. Other sources can include social media data, such as images and posts by the brand ambassadors. In certain implementations, items can be what the brand ambassadors use frequently or regularly that can be used in a marketing role. Example include clothing, such as t-shirts. Consideration can be made as to the space on the item for which branding can be placed, where branding can include a brand icon/log, brand tagline, brand theme (e.g., color, shade, etc.), etc. In certain cases, brand awareness items are made specifically for brand ambassadors.

At step 510, the determine items are offered to the brand ambassadors. The items can be offered as a gift or a discount. In certain implementations, factors such as the following can be considered: purchase history of the brand ambassador; other brand ambassadors in the same region; travel properties such as mode of transportation (e.g., car, walk, public transport, etc.), duration of travel, travel frequency; brand ambassador impact on sales (for certain implementations, brand ambassadors are identified by a code); etc. Items can be offered through various channels, such as online marketplace 214 described in FIG. 2. In certain implementations, the offer can be made before or during which a brand ambassador shops. At block 512, the process 500 ends.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method for deriving a region in which brand awareness is supported comprising:
detecting through a mobile shopper tracking analytics module as implemented on an information handling device, one or more mobile shoppers traveling in the region who can be brand ambassadors for a specific region, wherein the mobile shopper tracking analytics module receives and tracks data from various data sources including calendar information from the information handling device and online scheduling and data social media sources to derive expected travels of the mobile shoppers;
determining through artificial intelligence of the mobile shopper tracking analytics module items used as for the brand awareness for the one or more mobile shoppers; and
offering for free or a discounted price the determined items to the brand ambassadors.

2. The computer implemented method of claim 1, wherein the detecting is of regions in which the one or more mobile shoppers travel.

3. The computer implemented method of claim 1, wherein the detecting of one or more shoppers is based on routes travelled frequently and mode of transportation.

4. The computer implemented method of claim 1, wherein a region is an area or travel route.

5. (canceled)

6. The computer implemented method of claim 1, wherein the determining is based on items used frequently by the brand ambassadors.

7. The computer implemented method of claim 1, items that are offered are made to order items.

8. A system comprising:
a processor;
a data bus coupled to the processor; and
a computer-usable medium embodying computer program code, the computer-usable medium being coupled to the data bus, the computer program code used for deriving a region in which brand awareness is supported comprising instructions executable by the processor and configured for:
detecting through a mobile shopper tracking analytics module as implemented on an information handling device, one or more mobile shoppers traveling in the region who can be brand ambassadors for a specific region, wherein the mobile shopper tracking analytics module receives and tracks data from various data sources including calendar information from the information handling device and online scheduling and data social media sources to derive expected travels of the mobile shoppers;
determining through artificial intelligence of the mobile shopper tracking analytics module items used as for the brand awareness for the one or more mobile shoppers; and
offering for free or a discounted price the determined items to the brand ambassadors.

9. The system of claim 8, wherein the detecting is of regions in which the one or more mobile shoppers travel.

10. The system of claim 8, wherein the detecting of one or more shoppers is based on routes travelled frequently and mode of transportation.

11. The system of claim 8, wherein a region is an area or travel route.

12. (canceled)

13. The system of claim 8, wherein the determining is based on items used frequently by the brand ambassadors.

14. The system of claim 8, items that are offered are made to order items.

15. A non-transitory, computer-readable storage medium embodying computer program code, the computer program code comprising computer executable instructions configured for:
detecting through a mobile shopper tracking analytics module as implemented on an information handling device, one or more mobile shoppers traveling in the region who can be brand ambassadors for a specific region, wherein the mobile shopper tracking analytics module receives and tracks data from various data sources including calendar information from the information handling device and online scheduling and data social media sources to derive expected travels of the mobile shoppers;
determining through artificial intelligence of the mobile shopper tracking analytics module items used as for the brand awareness for the one or more mobile shoppers; and
offering for free or a discounted price the determined items to the brand ambassadors.

16. The non-transitory, computer-readable storage medium of claim 15, wherein the detecting is of regions in which the one or more mobile shoppers travel.

17. The non-transitory, computer-readable storage medium of claim 15, wherein the detecting of one or more shoppers is based on routes travelled frequently and mode of transportation.

18. The non-transitory, computer-readable storage medium of claim 15, wherein a region is an area or travel route.

19. (canceled)

20. The computer implemented method of claim 15, wherein the determining is based on items used frequently by the brand ambassadors.

21. The computer implemented method of claim 1, wherein another data source are messages and performing natural language processing when voice messages are searched.

22. The system of claim 8, wherein another data source are messages and performing natural language processing when voice messages are searched.

23. The non-transitory, computer-readable storage medium of claim 15, wherein another data source are messages and performing natural language processing when voice messages are searched.
